(19) United States
(12) Patent Application Publication
(10) Pub. No.: US 2005/0199838 A1
(43) Pub. Date: Sep. 15, 2005

(54) Medical suction device

(76) Inventor: Ronald D. Shippert, Littleton, CO (US)

Correspondence Address: SHERIDAN ROSS PC, 1560 BROADWAY, SUITE 1200, DENVER, CO, 80202, US

(21) Appl. No.: 10/800,329

(22) Filed: Mar. 12, 2004

(51) Int. Cl. F16K 7/04

(52) U.S. Cl. 251/4

(57) ABSTRACT

A valve for controlling fluid flow is provided. The valve may be used in a medical instrument, such as a liposuction device. The valve includes a valve stem, a handle, and a valve bore. The valve bore is located in the instrument body, and is tapered inwardly from the stem insertion end to a body closed end. The valve bore has a similar taper. A flange is attached to the body and includes a boss having a tapered surface which contacts the handle as the valve is moved from the closed position to the open position, for use in holding the valve with the body. As the valve is opened, a user can apply a force that causes the stem to move more inwardly in order to maintain the desired fit between the stem and the valve bore.

### FIELD OF THE INVENTION

This invention is directed to a medical instrument and in particular to a medical instrument for moving liquids, semisolids, air or vacuum.

### BACKGROUND

Present day suction devices typically include a suction tube, a body, a handle, and a suction or vacuum source. A valve may be included in these devices to control the application of vacuum to the suction tube. It is often useful to have the valve in or near the handle, so a user may control application of vacuum to the suction tube by hand at the handle. However, present valves used in such applications have drawbacks which prevent ease of use, reliability, and low cost manufacture.

One drawback of present day valves is that the valve members in the valve must be tightly held in place to prevent any vacuum leakage. In order to accomplish this, valves have separate parts, such as a spring, cap and screw, or “O” rings of various types. These multiple parts are often quite complex, having a multiplicity of complex angles, such as in screws and springs. The large number of parts results in difficulty in properly cleaning the device. Furthermore, the number of parts results in difficulty assembling and disassembling the instrument. Also, such devices are often secured to the body, such as by a screw, in order to prevent the parts from falling out. When assembling and disassembling the instruments, it is common to lose parts. Accordingly, it would be beneficial to have a valve with fewer parts, provided for more efficient cleaning, and relatively easy to assemble and disassemble.

Additionally, having many parts, while providing the required seals to prevent leakage, presents another set of problems. For example, if close tolerances are not met, the parts do not maintain a seal. Present day valves thus often not manufactured with parts having close tolerances, and require additional parts to complete the seal. Often, the parts are not able to be assembled and tightened enough to provide such a seal, resulting in loss of seal and leakage. In such cases, high viscosity grease is required to complete the seal. Assembling the parts to achieve a seal can take additional time and testing to verify the instrument has a proper seal. Furthermore, the addition of grease further complicates the cleaning process, as the grease must be removed with each cleaning and re-applied during the re-assembly of the valve. Accordingly, it would be beneficial to have a valve which provides a proper seal, without requiring adjustment of separate parts or the addition of grease.

Another problem often encountered in present valves is wear of the valve parts. Wear in such valves is often uneven, and as the contact areas wear the valve loses seal and must be tightened, or grease is used to complete the seal. Wear is also often encountered during the use of two different materials as the opposing sealing surfaces, with the softer material wearing at a much higher rate. Accordingly, it would be beneficial to have a valve which self adjusts for wear or parts, providing a seal without independent adjustment of parts within the valve.

Another problem with present day valves is in the use of “spring retention” type valves. These valves use a spring in the tightener which helps to provide a seal. Many valves have this type of construction because it is easy to tighten the seal using conventional tools. However, the multiple parts result in difficulty in properly cleaning the instrument, and inconvenient loss of parts. Accordingly, it would be beneficial to provide a valve which does not require a spring retention tightener, while maintaining a proper seal.

A further problem with many present day valves is that the valves have a uniformly cylindrical hole in the cross-shaft for material passage. To be fully open, the valve channel and the cross shaft channel must match up exactly. This creates additional difficulties in the assembly of the valve following any cleaning, as care must be taken to ensure the channels match up in the open position. Furthermore, if the handle used to open and close the valve travels more or less than the fully opened position, the valve will not be fully open, losing flow. Accordingly, it would be beneficial to have a valve which is fully open while not requiring the exact matching of the channels.

### SUMMARY

The present invention addresses the aforementioned problems and meets the aforementioned needs. The present invention provides a valve which has relatively few parts having simple assembly and operation, and which also work to prevent leakage from the valve.

In one embodiment, a medical suction device is provided which includes a body and a valve. The body includes a conduit and a valve bore. The valve includes a stem having a valve opening, a handle, and a flange. The flange is joined to the body, and at least a portion of the stem is positioned in the valve bore. The handle contacts the flange when the valve is in an open state in which fluid can move through the valve opening for passage through the conduit. The flange, in an embodiment, includes a boss and a channel, and the handle moves in the channel when the valve is changed from a closed state to the open state. The boss may have a tapered guide surface that tapers inwardly towards the body. The flange may be integral with the body. In an embodiment, at least one of the valve bore and the stem tapers inwardly from the handle, and the stem is held in the valve bore independently of any fastener. The body, in an embodiment, has a head with an inlet adjacent one end thereof and an outlet adjacent an opposite end thereof and in which the valve is located closer to the inlet than the outlet.

Another embodiment of the invention provides a valve as part of a medical suction device having a body and a valve bore formed in the body. The valve includes a flange joined to the body, a stem having an open state to allow passage of fluid through the valve and a closed state to substantially prevent passage of fluid through the valve, and a handle joined to the stem. The stem is held in said open state in the valve bore independently of any fastener. The flange may include a boss with a tapered guide surface and a channel adjacent to the tapered guide surface for receiving the handle. In an embodiment, the stem tapers inwardly away from the handle. In one embodiment, the flange is integral with the body. The stem, in an embodiment, is held in the valve bore substantially only by frictional force and contact between the flange and the handle.

In another embodiment, a method using a medical suction device for opening and closing a valve is provided. The valve includes a flange, a stem and a handle connected to the stem. The method comprises opening the valve, including engaging the handle and the flange while the handle is being moved. The opening of the valve includes causing inward movement of the stem. In an embodiment, the flange has a tapered guide surface that is contacted by the handle. In one embodiment, the valve is fully opened by moving the handle a first distance and further including, at a later time, opening again the valve to be fully opened while moving the handle a second distance greater than the first distance. The medical suction device may include a body and a valve bore and the stem is held with the body substantially only by engagement between the handle and the flange and friction between the stem and the valve bore. The medical suction device may also include a body, and the stem is held with the body independently of any fastener.

The above described features and advantages of the invention will become more apparent from a review of the following description, taken in conjunction with the accompanying drawings.

### BRIEF DESCRIPTION OF THE DRAWINGS

FIG. 1 is a perspective view illustrating a medical device of one embodiment of the present invention;

FIG. 2 is a top plan view of the medical device of FIG. 1;

FIG. 3 is a side elevation view of the medical device of FIG. 1, illustrating the handle of the device in the open and closed positions;

FIG. 4 is a front elevation view of the medical device of the medical device of FIG. 1;

FIG. 5 is a partial cross-section view of the valve portion of the medical device of FIG. 1;

FIG. 6A is a side elevation view of the valve portion of the medical device of FIG. I illustrating the valve in a closed position;

FIG. 6B is a front elevation view corresponding to FIG. 6A;

FIG. 7A is a side elevation view of the valve portion of the medical device of FIG. I illustrating the valve in a partially open position;

FIG. 7B is a front elevation view corresponding to FIG. 7A;

FIG. 8A is a side elevation view of the valve portion of the medical device of FIG. 1 illustrating the valve in an open position; and

FIG. 8B is a front elevation view corresponding to FIG. 8A.

### DETAILED DESCRIPTION

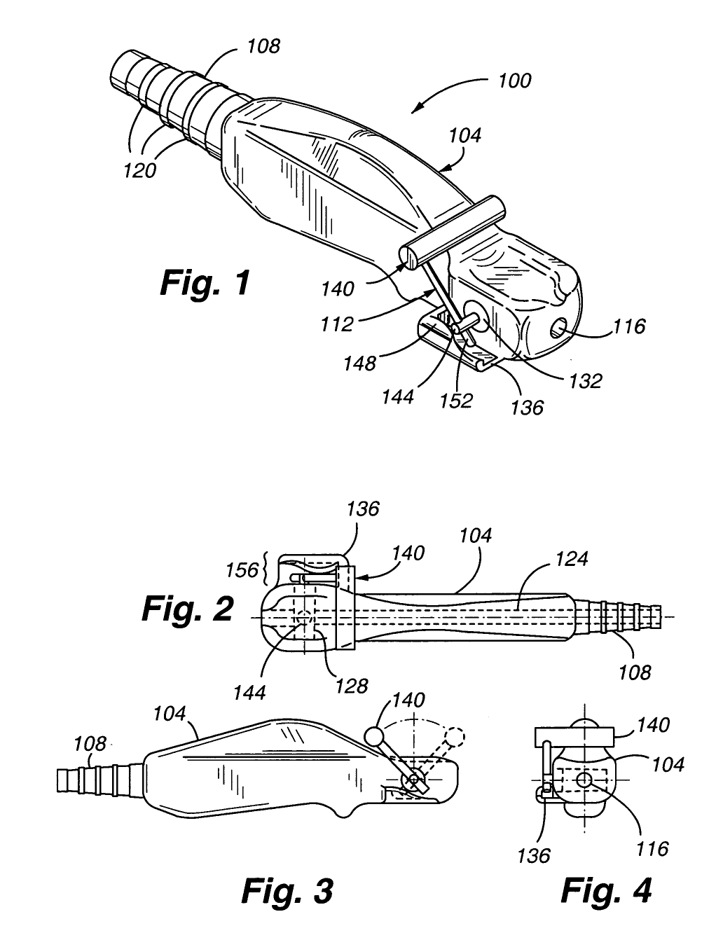

One embodiment of the present invention is illustrated in FIG. 1. In this embodiment, a valve of the present invention is incorporated into a medical device 100 which may be used in a liposuction procedure. It will be understood that the present invention may have additional uses, other than in medical devices, and that the invention is not limited to the exemplary embodiments described herein. The device of FIG. 1 includes a body 104, which has a outlet 108 for an external vacuum source, a valve 112 and an inlet 116 to which various probe attachments or tubes (not shown) may be coupled. The body 104, outlet 108, and inlet 116, are formed from an integral piece of material, such as stainless steel, in one embodiment. In an embodiment, portions of the valve 112 are also formed integrally with the body 104, as will be described in more detail below. In other embodiments, the various portions of the device 100 are fabricated as separate pieces and assembled to form the device 100. The outlet 108, in the embodiment of FIG. 1, is tapered and includes several barbs 120 which help secure a vacuum tube or hose (not shown) to the outlet 108. The outlet 108, may also include a threaded fitting which may be connected to an associated fitting on a vacuum tube or hose. As will be understood, numerous other connections may be used to connect a vacuum or suction source to the device 100. The inlet 116, in the embodiment of FIG. 1, is a socket into which a probe attachment may be inserted. Similarly as described with the connection 108, the inlet 116 may be one of numerous coupling structures which couples the body 104 to a working portion of the device which requires suction. Also, the device may include an integral probe attachment. Furthermore, the inlet 116 may be a fitting to which a hose or tube may be attached.

Referring to FIG. 2, the device 100, as indicated by the dashed lines, includes a conduit 124, and a valve bore 128. Referring now to FIGS. 1 through 4, the valve 112, may be used in turning on and off suction between the connection 108 and the inlet 116. The valve 112 is made up of the valve bore 128 within the body, a stem 132 that can include a knob 144 which is inserted into the valve bore 128, a flange 136 attached to the body 104, and a handle 140 which can be turned to rotate the valve stem 132 within the valve bore 128. The valve stem 132 includes a valve opening 146, which, when the handle 140 is turned, is rotated into and out of alignment with the conduit 124 within the body 104, thus applying and removing vacuum from the inlet 116. Movement of the handle is illustrated in FIG. 3, with the solid lines indicating the position of the handle 140 in the closed position, where no vacuum or suction is applied to the inlet 116, and the dashed lines indicating the position of the handle 140 in the open position, where suction or vacuum is applied to the inlet 116. FIG. 4 illustrates a front view of the device 100, with the valve bore 128 illustrated in dashed lines.

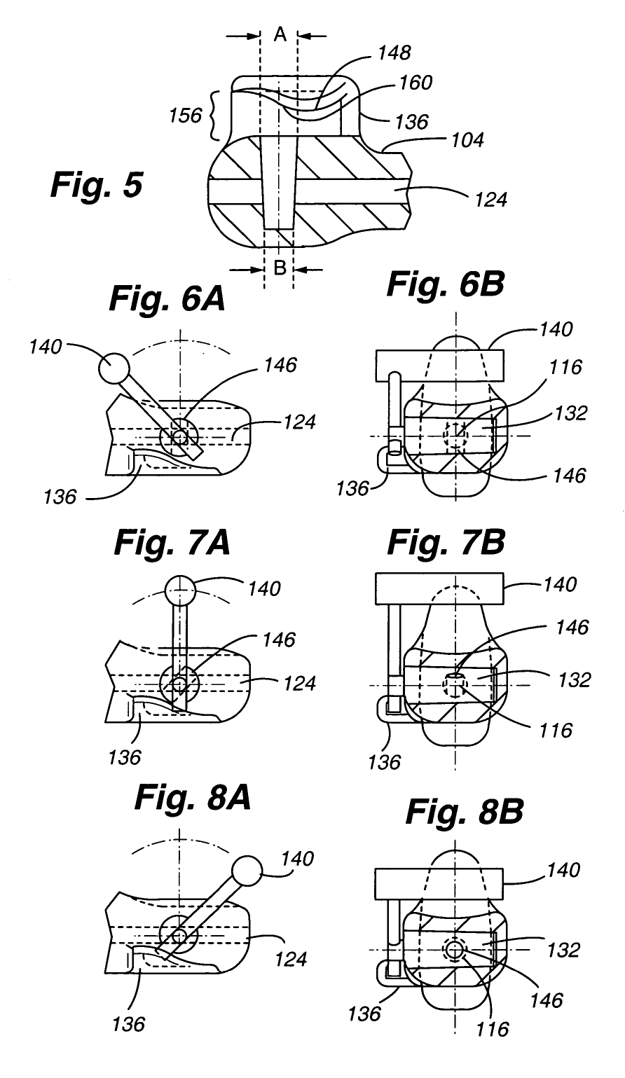

The flange 136, in an embodiment, includes a boss 148 which has a tapered configuration and contacts the handle 140 as the handle is turned. The boss 148 and the body 104 create a channel 156 between the boss 148 and body 104. In the embodiment illustrated, the handle 140 can include an extension 152 which extends beyond the knob 144, into the channel 156, and contacts the boss 148 as the handle 140 is moved from the closed position to the open position. Referring now to FIG. 5, a partial cross-section view of the valve is illustrated, including the conduit 124, valve bore 128, flange 136 and boss 148. As can be observed from the illustration of FIG. 5, the valve bore 128 is tapered inwardly from the flange 136. The taper results in the valve bore 128 having a diameter A at the end adjacent to the flange 136, and a diameter B at the end within the body 104, with B being smaller than A. The valve stem 132 is tapered to correspond to the taper of the valve bore. The boss has a tapered guide surface 160 that tapers inwardly towards the body 104. In an embodiment, the handle 140 contacts the tapered guide surface 160 as the valve is moved from the closed to the open position. As the handle 140 contacts the tapered guide surface 160, the valve stem 132 is forced further into the valve bore 128. Accordingly, as the valve is moved farther into the open position, the valve stem 132 makes tighter contact with the valve bore 128, which helps prevent any leakage from the valve 112.

Referring now to FIGS. 6-8, the operation of the valve 112 as it is moved from the closed position to the open position is described in more detail. Initially, as illustrated in the side view of FIG. 6A and the front view of FIG. 6B, the valve 112 is in the closed position. While in the closed position, the valve opening 146, illustrated in dashed lines within the valve stem 132 is oriented substantially perpendicular to the conduit 124 within the body 104. The handle 104 is generally oriented in a position where it is relatively closer to the connection 108 side of the body 104. In this position, the extension 152 is not in contact with the flange 136. In one embodiment, when in the closed position, the valve stem 132 may be removed from the valve bore 128 simply by pulling on the knob 144 of the valve stem 132. As the handle 140 is moved away from the body 104, the valve 112 begins to open. FIGS. 7A and 7B illustrate the valve 112 as it is moved from the closed position to the open position. At the position illustrated in FIGS. 7A and 7B, the extension 152 of the handle 140 is initially coming into contact with the flange, and the valve opening 146 is beginning to become aligned with the conduit 124. Finally, as illustrated in FIGS. 8A and 8B, the valve 112 is in the open position, with the valve opening 146 substantially aligned with the conduit 124, thus allowing vacuum to be applied to the inlet 116. As the handle 140 is moved away from the body, the handle extension 152 contacts the tapered guide surface 160 of the boss 148 on the flange 136, forcing the valve stem 132 into the valve bore 128. As mentioned above, the valve stem 132 being forced into the valve bore 128 results in substantially no leakage of suction or vacuum through the valve 112. A user, while operating the valve 112, may observe some leakage, and simply apply more pressure to the handle 140, thus forcing the valve stem 132 into tighter connection with the valve bore 128, thereby reducing the leakage.

During repeated use of the valve 112, parts of the valve 112 may wear. For example, the valve stem 132 may wear to result in a smaller physical diameter over time. Similarly, the valve bore 128 may become enlarged. A seal may be maintained in the valve 112 by moving the handle 140 a farther distance into the channel 156, thus forcing the stem 132 farther into the valve bore 128 and maintaining a seal. Thus, the valve 112 can be operated repeatedly without having to make separate adjustments to the valve in order to maintain a seal. Furthermore, the stem 132 and handle 140 may be removed from the body 104 by moving the handle 140 into the farthest closed position possible, resulting in no portions of the handle extending into the channel 156. The handle 140 and stem 132 may then be pulled from the body 104, thus disassembling the valve 112. The valve 112 may be assembled simply by inserting the stem 132 into the valve bore 128. Accordingly, assembly and disassembly may be accomplished with relative ease and the device may be properly cleaned with relative ease.

In another embodiment, the stem 132 includes a valve opening 146 which has a larger diameter than the conduit 124. Accordingly, the device may achieve maximum suction without requiring the valve opening 146 to be precisely aligned with the conduit 124. Also, as the valve 112 wears over time, the handle 140 is moved different distances to achieve a fully opened configuration while maintaining a seal. Having a valve opening 146 which has a larger diameter than the conduit 124 allows the valve 112 to be fully opened even as the valve wears. In another embodiment, the valve opening 146 has an oval shape, allowing the valve 112 to achieve maximum suction when the handle 140 is moved a distance other than the optimum distance for fully opening the valve while maintaining a seal. The handle and body, in a further embodiment, include a surface allowing for an enhanced gripping for a user of the device, such as a knurled surface or a rubberized surface.

As mentioned above, the body 104, outlet 108, inlet 116, and flange may be formed from an integral piece of material, such as stainless steel. However, other materials may be used, such as, for example, plastic, brass, or a composite material. The flange 136, outlet 108, or inlet 116 may be manufactured separately from the body and fastened thereto during manufacturing. The valve 112 may also include additional parts, such as an insert which may be inserted into the body 104 and which acts as the valve bore 128. In this embodiment, the body 104 may be made of a first material, such as plastic, and the insert may be made of a second material, such as a metal. The metal of the insert in such a case may provide for enhanced durability of the device, as the metal wears more slowly than plastic during repeated use of the device. Furthermore, the stem 132 material may be selected from a softer material than the valve bore 128, resulting in the stem 132 wearing more quickly than the valve bore 128. Thus, the stem 132 may be easily replaced upon wearing out, while the valve bore 128 and the body 104 may continue to be used.

While the embodiments described above are directed to a hand operated medical suction device, many other devices may incorporate the valve herein described. For example, the valve may be incorporated into a foot operated device which applies and removes suction from a working head based on the foot action of a user, thus leaving both hands of the user free to perform other tasks. The valve may be incorporated into a device which has an electronic actuation, with the valve stem turned relative to the valve bore by an electric and/or mechanical device attached to the valve stem, which is actuated by an electronic signal which may be generated automatically or manually.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best modes presently known of practicing the inventions and to enable others skilled in the art to utilize the inventions in such, or in other embodiments, and with the various modifications required by their particular application or uses of the invention. It is intended that the appended claims be construed to include alternative embodiments to the extent permitted by the prior art.

1. A medical suction device, comprising:
a body including a conduit and a valve bore; and
a valve including a stem having a valve opening, a handle, and a flange, said flange joined to said body and at least portions of said stem positioned in said valve bore;
wherein said handle contacts said flange when said valve is in an open state in which fluid can move through said valve opening for passage through said conduit.

2. A medical suction device of claim 1 wherein said flange includes a boss and a channel and in which said handle moves in said channel when said valve is changed from a closed state to said open state.

3. A medical suction device of claim 2 wherein said boss has a tapered guide surface that tapers inwardly towards said body.

4. A medical suction device of claim 1 wherein said flange is integral with said body.

5. A medical suction device of claim 1 wherein at least one of said valve bore and said stem tapers inwardly from said handle.

6. A medical suction device of claim 1 wherein said stem is held in said valve bore independently of any fastener different from said flange.

7. A medical suction device of claim 1 wherein said body has a head with an inlet adjacent one end thereof and an outlet adjacent an opposite end thereof and in which said valve is located closer to said inlet than said outlet.

8. A medical suction device of claim 1 wherein said valve consists of said stem, said handle, said knob and said flange.

9. A valve as part of a medical suction device having a body and a valve bore formed in said body, comprising:
a flange joined to said body;
a stem having an open state to allow passage of fluid through said valve and a closed state to substantially prevent passage of fluid through said valve; and
a handle joined to said stem;
wherein said stem is held in said open state in said valve bore independently of any fastener.

10. A valve of claim 9 wherein said flange includes a boss with tapered guide surface and a channel adjacent to said tapered guide surface for receiving said handle.

11. A valve of claim 9 wherein said stem tapers inwardly away from said handle.

12. A valve of claim 9 wherein said flange is integral with said body.

13. A valve of claim 9 wherein said stem is held in said valve bore substantially only by frictional force and contact between said flange and said handle.

14. A method using a medical suction device for opening and closing a valve that includes a flange, a stem and a handle connected to said stem, comprising:
opening said valve including engaging said handle and said flange while said handle is being moved.

15. A method of claim 14 wherein said opening includes causing inward movement of said stem.

16. A method of claim 15 wherein said flange has a tapered guide surface that is contacted by portions of said handle.

17. A method of claim 14 wherein said valve is fully opened by moving said handle a first distance and further including, at a later time, opening again said valve to be fully opened while moving said handle a second distance greater than said first distance.

18. A method of claim 14 wherein said medical suction device includes a body and a valve bore and said stem is held with said body substantially only by engagement between said handle and said flange and friction between said stem and said valve bore.

19. A method of claim 14 wherein said medical suction device includes a body and said stem is held with said body independently of any fastener.
